(19) United States
(12) Patent Application Publication
(10) Pub. No.: US 2017/0152709 A1
(43) Pub. Date: Jun. 1, 2017

(54) CAN CADDIE

(71) Applicant: Charles F. PAGELS, Hertford, NC (US)

(72) Inventor: Charles F. PAGELS, Hertford, NC (US)

(21) Appl. No.: 14/954,076

(22) Filed: Nov. 30, 2015

(51) Int. Cl. E06C 7/14

(52) U.S. Cl. CPC E06C 7/143

(57) ABSTRACT

A can caddie for securing a platform to either of two different hollow rung sizes is provided. The can caddie provides a collar portion coupled between a shaft and a platform portion. The shaft has a stirrup shape dimensioned and adapted to snugly fit in the hollow rung of a smaller home use ladder, preventing rotation therein. The collar portion is dimensioned and adapted to snugly fit a larger hollow rung of a commercial ladder, preventing rotation therein. Also, the collar portion may be adapted so as to prevent pivoting of the shaft within the smaller hollow rung by engaging the opening thereof. The platform portion includes a can opening and a plurality of can notches to receive a paint can and its handle, respectively, so as to be secured by gravity. The platform portion is also designed to retain tools and other items.

### BACKGROUND OF THE INVENTION

The present invention relates to devices for removably securing tools to a ladder, and, more particularly, to a device for securing a platform to at least two different ladder hollow rung sizes, wherein the platform is adapted to retain a paint can and other items in a stable manner for a user of the ladder.

When standing upon a ladder it is difficult to hold a paint can and other items which are needed to complete a task.

Current devices either hang a can from a ladder rung upon a hook type assembly or have a round shaft which fits into the ladder rung, both do not afford a high level of stability when using the paint can or the other items. Items hung from hooks tend to wobble and can be hard to control when accessing the paint can or other items. Other devices that go into the rung of the ladder tend to rotate, pivot and/or rock within the hollow rung, providing an instable means for securing paint cans or other items.

Predominantly there are two different sizes of hollow rung based on the type of use the ladder is designed for. Typically, a first, larger hollow rung is associated with “commercial” ladders rated for accepting heavier weight in their use. A second, smaller sized hollow rung is associated with “home use” ladders rated for less weight than their commercial counterparts. Current ladder securing devices are not dual operational of the different hollow rung sizes. Thus the current ladder securing devices either will not fit in the smaller hollow rung because they are designed for the larger counterpart. Or if they are designed for the smaller internal hollow rung, when in the larger counterpart, they tend to rock and pivot within the hollow rung due to the mismatch in the device's shaft and the size of the larger hollow rung.

As can be seen, there is a need for a device for securing a platform to at least two different ladder hollow rung sizes, wherein the platform is adapted to retain a paint can and other items in a stable manner for a user of the ladder.

### SUMMARY OF THE INVENTION

In one aspect of the present invention, a can caddie for removably securing a platform to a ladder having at least one hollow rung includes a shaft extending from a first end to a second end, wherein the shaft has a stirrup shape; a collar portion coupled to the second end, wherein the collar portion forms the stirrup shape dimensioned proportionally greater than the stirrup shape of the shaft; and a platform portion coupled to the collar portion opposite the shaft, wherein the platform portion includes a can opening.

In another aspect of the present invention, a can caddie for removably securing a platform to a ladder having at least one hollow rung includes a shaft extending from a first end to a second end, wherein the shaft has a first stirrup shape dimensioned and adapted to snugly fit within a first lumen of a first hollow rung; a collar portion coupled to the second end, wherein the collar portion forms a second stirrup shape dimensioned and adapted to snugly fit in a second lumen of a second hollow rung, wherein the second stirrup shape is proportionally greater than the first stirrup shape, each stirrup shape having a flat portion; a platform portion coupled to the collar portion opposite the shaft, wherein the platform portions provides first and second apertures, first and second cutouts, and a groove; and a can opening formed in the platform portion, wherein the can opening is dimensioned to receive a standard sized paint can, wherein the platform portion provides a plurality of can notches disposed along a circumference of the can opening so that each of the plurality of can notches is diametrically opposed to another of the plurality of can notches, and wherein the collar portion and the second end are coupled so that the flat portion of each stirrup shape are generally flush with each other.

These and other features, aspects and advantages of the present invention will become better understood with reference to the following drawings, description and claims.

### BRIEF DESCRIPTION OF THE DRAWINGS

FIG. 1 is a top plan view of an exemplary embodiment of the present invention;

FIG. 2 is a bottom plan view of an exemplary embodiment of the present invention;

FIG. 3 is a left side elevation view of an exemplary embodiment of the present invention;

FIG. 4 is a right side elevation view of an exemplary embodiment of the present invention;

FIG. 5 is a perspective view of an exemplary embodiment of the present invention;

FIG. 6 is a rear elevation view of an exemplary embodiment of the present invention; and

FIG. 7 is a front elevation view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a can caddie for securing a platform to either of two different hollow rung sizes. The platform is adapted to retain a paint can and other items in a stable manner for a user of the ladder. The can caddie provides a collar portion coupled between a shaft and a platform portion. The shaft has a stirrup shape dimensioned and adapted to snugly fit in the hollow rung of a smaller home use ladder, preventing rotation therein. The collar portion is dimensioned and adapted to snugly fit a larger hollow rung of a commercial ladder, preventing rotation therein. Also, the collar portion may be adapted so as to prevent pivoting of the shaft within the smaller hollow rung by engaging the opening thereof. The now-stabilized platform portion includes a can opening and a plurality of can notches to receive a paint can and its handle, respectively, so as to be secured by gravity. The platform portion also includes additional cutouts and apertures to securely retain other items and tools.

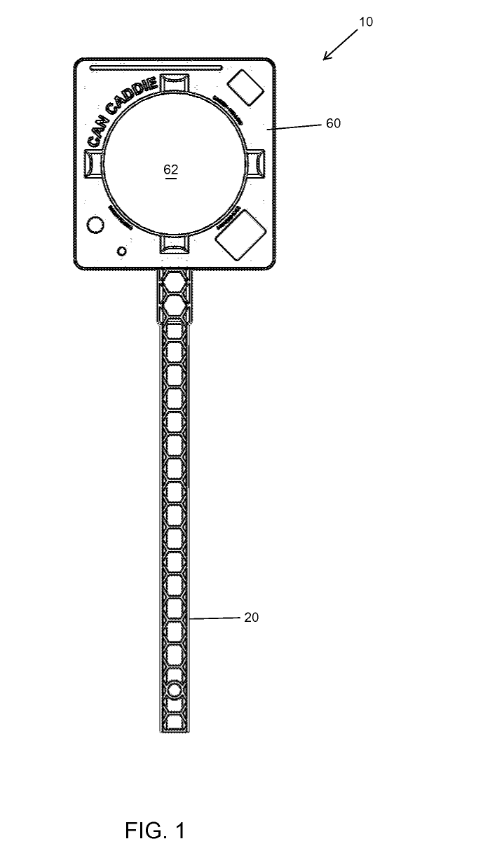

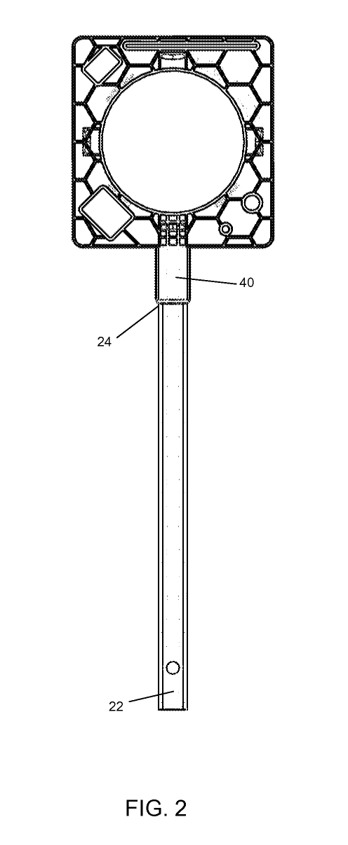

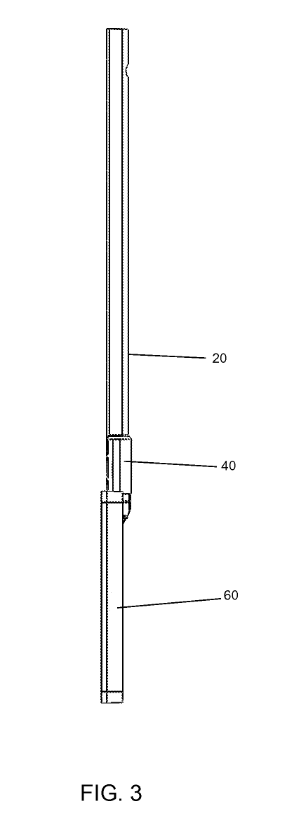

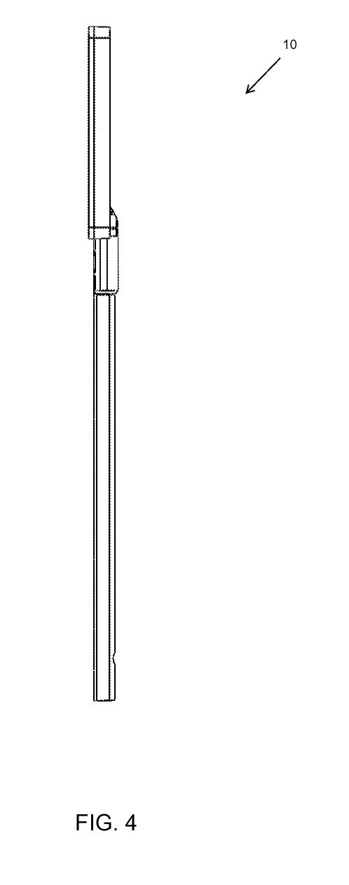

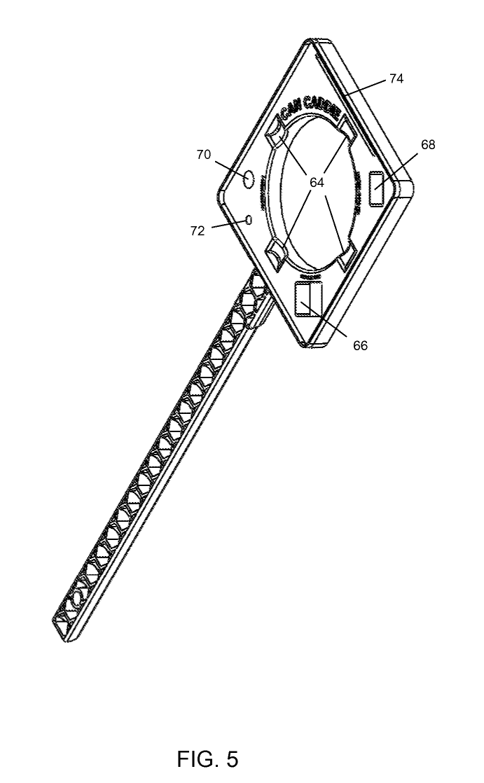

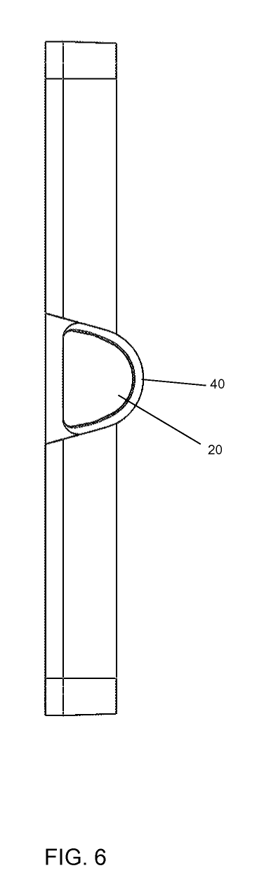

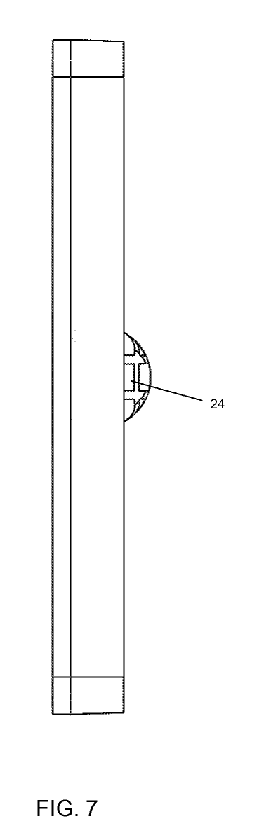

Referring to FIGS. 1 through 7, the present invention may include a can caddie 10. The can caddie 10 may include a shaft 20, a collar portion 40 and a platform portion 60 sequentially coupled. The shaft 20 extends from a first end 22 to a second end 24. The second end 24 is coupled to the collar portion 40, while the platform portion 60 is coupled to the opposing side of the collar portion 40, whereby the collar portion 40 interconnects the shaft 20 and the platform portion 60, as illustrated in the figures.

The shaft 20 may include honeycomb reinforcement to strengthen the shaft. The same honeycomb reinforcements may also be included along the platform portion 60.

The shaft 20 may be shaped and dimensioned to be slidably and snugly received inside a first hollow rung size associated with a smaller home use ladder. In certain embodiments, the shaft 20 may have a stirrup-shaped, as illustrated in the figures, dimensioned and adapted to prevent rotation about a longitudinal axis by substantially conforming to the shape of the lumen formed by the hollow rung.

The collar portion 40 may be the same stirrup shape as the shaft 20 but dimensioned proportionally larger so that the collar portion 40 snugly fits in a second hollow rung associated with commercial ladders. In certain embodiments, this proportional relationship may be in the range of five to ten percent. The collar portion 40 and the shaft 20 may be coupled so that the flat portions of their stirrup shapes are generally flush.

While the shaft 20, the collar portion 40 and the platform portion 60 may be made of resilient material, such as nylon plastic, the collar portion 40 may be made of elastic material in certain embodiments. Such elastic material may be deformable so that when it encounters an opening of the first, smaller hollow rung, after the shaft 20 have been received, the elastic collar portion 40 may deform to snugly fill or wedge into a opening of the lumen of the first hollow rung, and be fix thereto. In certain embodiments, an edge of the collar portion 40 may be wedged shaped to facilitate the filling/wedging of the opening of the first hollow rung.

The platform portion 60 may be generally planar and of sufficient size to accommodate a can opening 62, a plurality of can notches 64, a first cutout 66, a second cutout 68, a first aperture 70, a second aperture 72 and a groove 74 so that they function in accordance with the present invention as described herein. The groove 74 may be dimensioned and adapted to secure a planar sheet, like an instruction card, or a writing implement or similarly shaped, elongated putty tool. The first aperture 72 may be dimensioned and adapted to secure the writing implement or similarly shaped, elongated tool is an orientation transverse to the groove 74. The second aperture 70 may be dimensioned and adapted to secure the screw driver or similarly shaped, elongated tool but in an orientation transverse to the groove 74. The first cutout 66 may be dimensioned and adapted to secure a tool, such as a hammer. The second cutout 68 may be dimensioned and adapted to secure a tool, such as a paint brush.

The can opening 62 may be dimensioned and adapted to slidably receive a cylindrical paint can of standard size so that the handle of the paint can catches on the platform portion 60, whereby the paint can is held by gravity. The can opening 62 is centrally disposed within the platform portion so that the overturning moment imposed by the received paint can about the ladder rung is minimized. The plurality of can notches 64 may be spaced along the circumference of the can opening 62 so that each can notch 64 has a diametrically opposed corresponding can notch 64, as illustrated in the figures. The corresponding can notches 64 may be dimensioned and adapted to securely retain the handle of the paint can so that a brim of an opening of the paint can is substantially flush with a top surface of the platform portion 60. The plurality of corresponding can notches 64 prevent the paint can from unintentionally rotating in the can opening 62, as well as provide structure so that the paint can may be intentionally rotated within the can opening 62 for enabling retention at different rotated orientations. It being understood that the “paint can” may hold paint or other contents typically used on a ladder for home repair, for example caulk or other non-viscous solids that tend to gather and adhere to certain portions on the inside of the “paint can.”

The shaft 20, collar portion 40 and platform portion 60 forms an integrated unit. Thus no assembly is required, which is an advantage over the complexity of the prior art.

The can caddie 10 as described and claimed herein provides a number of benefits over the prior art. Mainly the can caddie 10 is dual operational in that a user may insert the shaft 20 into a hollow rung of a home use ladder or insert the shaft 20 and the collar portion 40 in a larger hollow rung of a commercial ladder. In certain embodiments, when securing to the smaller home use ladder, the collar portion 40 may be of an elastic material that engages the opening of the smaller hollow rung whereby a secure attachment is formed, preventing rocking or pivoting of the shaft 20 in the lumen of the smaller hollow rung. Advantageously, this secure collar attachment enables the user to load the platform portion 60 with a heavy paint can and other items yet the shaft 20 does not pivot insides the rung, much less rotate. This is critical because the moment induced from pivoting may cause items to fall off the platform portion 60, paint to spill from a full paint can secured within the can opening 62, make the ladder less stable, make applying items to the cutouts and openings of the platform portion more difficult, and the like.

A method of using the present invention may include the following. The can caddie 10 as disclosed and described above may be provided. A user may snugly insert the shaft 20 into a hollow rung of a home use ladder up until the collar portion 40. In certain embodiments, the user may insert the shaft 20 into a hollow rung of a home use ladder until the collar portion 40 securely wedges into the opening of the hollow rung. If using a commercial ladder with larger hollow rungs, the user may insert the shaft 20 and the collar portion 40 in such larger lumen so that the collar portion 40 forms a snug fit therein. In any case, the user may then place a paint can in the can opening 62 so that the handle of the paint can securely engages two corresponding can notches 64. The user may also attach tools and other accessories to the cutouts 66, 68, apertures 70, 72 and the groove 74 provided by the platform portion 60. Then the user may conveniently employ the above mentioned items while they work from the ladder, whereby the platform portion 60 provides a stable base that does not rotate nor pivot when in use.

It should be understood, of course, that the foregoing relates to exemplary embodiments of the invention and that modifications may be made without departing from the spirit and scope of the invention as set forth in the following claims.

1. A can caddie for removably securing a platform to a ladder having at least one hollow rung, comprising:
a shaft extending from a first end to a second end, wherein the shaft has a stirrup shape;
a collar portion coupled to the second end, wherein the collar portion forms the stirrup shape dimensioned proportionally greater than the stirrup shape of the shaft; and
a platform portion coupled to the collar portion opposite the shaft, wherein the platform portion includes a can opening.

2. The can caddie of claim 1, wherein the collar portion is made of elastic material.

3. The can caddie of claim 1, wherein the stirrup shape of the shaft is proportionally smaller than the stirrup shape of the collar portion by a range of five to ten percent.

4. The can caddie of claim 1, wherein the stirrup shape has a flat portion, and wherein the collar portion and the second end are coupled so each flat portion of each stirrup shape are generally flush.

5. The can caddie of claim 1, wherein the platform portion provides a plurality of can notches disposed along a circumference of the can opening so that each of the plurality of can notches is diametrically opposed to another of the plurality of can notches.

6. The can caddie of claim 1, wherein the platform portion provides first and second apertures, first and second cutouts, and a groove.

7. The can caddie of claim 1, wherein the can opening is dimensioned to receive a standard sized paint can.

8. The can caddie of claim 1, wherein the stirrup shape of the shaft is dimensioned and adapted to snugly fit in a first lumen of a first hollow rung.

9. The can caddie of claim 7, wherein the collar portion is dimensioned and adapted to snugly fit in a second lumen of a second hollow rung associated with a commercial ladder.

10. A can caddie for removably securing a platform to a ladder having at least one hollow rung, comprising:
a shaft extending from a first end to a second end, wherein the shaft has a first stirrup shape dimensioned and adapted to snugly fit within a first lumen of a first hollow rung;
a collar portion coupled to the second end, wherein the collar portion forms a second stirrup shape dimensioned and adapted to snugly fit in a second lumen of a second hollow rung, wherein the second stirrup shape is proportionally greater than the first stirrup shape, each stirrup shape having a flat portion;
a platform portion coupled to the collar portion opposite the shaft, wherein the platform portion provides first and second apertures, first and second cutouts, and a groove; and
a can opening formed in the platform portion, wherein the can opening is dimensioned to receive a standard sized paint can,
wherein the platform portion provides a plurality of can notches disposed along a circumference of the can opening so that each of the plurality of can notches is diametrically opposed to another of the plurality of can notches, and
wherein the collar portion and the second end are coupled so that the flat portion of each stirrup shape are generally flush with each other.
